(19) United States
(12) Patent Application Publication
(10) Pub. No.: US 2006/0130399 A1
(43) Pub. Date: Jun. 22, 2006

(54) POLE BASE

(76) Inventor: Thomas G. McDonald, Prospect Heights, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/163,274

(22) Filed: Oct. 12, 2005

Related U.S. Application Data
(60) Provisional application No. 60/617,985, filed on Oct. 12, 2004.

(51) Int. Cl. A01C 1/00; A01G 7/00

(52) U.S. Cl. 47/58.1 SE

(57) ABSTRACT

A mat configured to mount at or around the base of a post to prevent vegetation from growing around the post base and facilitates landscaping around the post is disclosed. The mat has a slot that radiates from a center portion to an outer edge. The slot has interlocking slot sides that mate together to form a seamless or nearly seamless appearance. The center portion can be configured to tightly fit around the outer perimeter of the post. A post cone may be added to or integrally formed with the mat. The post cone extends vertically up the post and provides additional contact area between the post and the mat. Preferably the mats is flexible, maintains its shape during exposure, and thin enough to not interfere with landscaping equipment, but thick enough to provide sufficient weight to allow the mat to maintain contact with the ground.

### CROSS REFERENCE TO RELATED APPLICATIONS

This application claims the benefit of the following U.S. Provisional Patent Application No. 60/617,985, filed Oct. 12, 2004, which is hereby incorporated by reference in its entirety.

### FIELD OF THE INVENTION

The present invention relates to pole or post systems, and more specifically to a mat configured to mount at or about the base of the pole such that vegetation is prevented from growing around the base of the pole and further facilitates mowing grass in the area of the pole.

### DESCRIPTION OF THE RELATED ART

The placing of mats or rings around poles or trees is know. Mats or rings are placed around poles or trees for a variety of reasons. Some mats prevent vegetation growth, some act as mulch, allowing water and nutrients to reach the ground. Other mats or rings are designed to hold mulch or decorative stone around the tree or post. Many of these mats are pinned or otherwise positively secured to the ground.

A first example of a previous design is shown in U.S. Pat. No. 5,396,731, issued to Byrne. The Byrne patent, discloses a preformed mulch pad that has a central trunk receiving aperture and a partially pre-cut, re-lockable slit which can be torn and then rejoined for disposition of the pad around a tree. The pad is porous and prevents moisture and air transmission to underlying root system while insulating them. The pad is constructed from a mixture of rubber granules, buffings, fibers ground from used tires, a curable binder and coloring, catalyst and anti-gloss agents. U.V. light stabilizers and anti-oxidants may also be included in the pad material.

Another landscaping mat is shown in U.S. Pat. No. 5,323,557, issued to Sonntag. The Sonntag patent discloses a landscaping mat for surrounding a tree trunk and upstanding posts to as to eliminate the need to mow and trim around the tree or post. The Sonntag mat includes a flexible inner portion, and intermediate portion surrounding the inner portion, and an outer portion surrounding the intermediate portion. The intermediate portion is thicker than the inner portion, and the outer portion is tapered to an outer perimeter edge. A slit extends from the perimeter edge to a central opening in the inner portion so as to allow the mat to be placed in position around a tree trunk or post. Alternatively, the slit may extend through the diameter of the mat so as to define two mirror image mat sections. Concentric scored lines are provided around the central opening and can be cut so as to increase the diameter of the opening so as to accommodate different sized tree trunks or posts. A rib may be provided on the intermediate portion for retaining ornamental materials, such as rocks, bark, wood chips, or mulch. Alternatively, the upper surface of the mat may be textured and colored so as to resemble such ornamental materials.

While these previous designs may be operative, there remains substantial room for improvement and innovation in the area of pole and post base mats. Particularly, there remains a need for a device that can prevent vegetation growth around the base of a pole or post and facilitate mowing of grass or other landscaping tasks in the area of the post. Thus, it would be advantageous to provide a mat that can securely fit about the base of a pole and withstand the forces created by landscaping equipment or weather.

### SUMMARY

In view of the deficiencies described above, it is an object of the present invention to provide a pole base that prevents vegetation growth around the base of the pole.

It is a further object of the present invention to provide a pole base that tightly fits about the base of the pole and can withstand the forces created by landscaping equipment or weather.

The present invention is a mat or pad configured to mount at or about the base of a pole or post such that vegetation is prevented from growing around the base of the pole or post and further facilitates mowing grass in the area of the pole or post. According to the present invention the mat has a slot that radiates from a center portion to an outer edge. Sides of the slot can be configured to interlock or mate together such that when the slot is in a closed position, the slot sides form a seamless or nearly seamless appearance.

The center portion can be configured to match the outer perimeter of the post. By matching the shape of center portion to the outer perimeter of the post, the mat can be tightly fitted around the post. A tight fit of the mat around the post, along with a suitably weighted material, helps the mat grip the post such that the mat will not be lifted off the ground unintentionally, such as by winds or landscaping equipment. A tight fit also prevents grasses, weeds, or other vegetation from growing between the mat and the post.

A post cone may be added to or integrally formed with the mat. The post cone extends vertically up the post such that the inner surface of the post cone provides additional contact area between the post and the mat. The post cone can extend either partially or completely up the length of the post. The added contact area increases the grip of the mat on the post, thereby reducing the likelihood the mat will lifted from the ground. The increased contact area also reduces the chance of vegetation growing between the mat and the post. The post cone can also protect the base of the post from landscaping equipment or other items operating in the vicinity of the post. Furthermore, the post cone can improve the aesthetic appearance of the post by concealing rust or other blemishes on the post base.

The mat can be constructed from a variety of materials. Preferably the mat is flexible such that it can be installed around the post and can maintain its shape during long term exposure to a range of weather conditions and temperatures. The mat should be thin enough to not interfere with landscaping equipment, but should be thick enough to provide sufficient weight so that the mat maintains contact with the ground.

In various preferred embodiments, a mat can be configured for a multiple post application, such as a road sign having two or more support posts. In these embodiments, there are center portions for each of the posts. The slot or slots can be configured such that there is a separate slot for each center portion or a single slot that allows access to each center portion, or a combination thereof.

Other features and advantages of the invention will be apparent from the following detailed description taken in conjunction with the following figures, wherein like reference numerals represent like features.

### BRIEF DESCRIPTION OF THE FIGURES

FIG. 1A shows a pole mat according to the present invention with the slot in a closed position.

FIG. 1B shows a pole mat according to the present invention with the slot in an open position.

FIG. 2 shows pole mat according to the present invention having a post cone.

FIG. 3 shows a pole mat according to the present invention for a multiple post application.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a mat or pad configured to mount at or around the base of a pole or post such that vegetation is prevented from growing around the base of the pole or post and further facilitates mowing grass in the area of the pole or post.

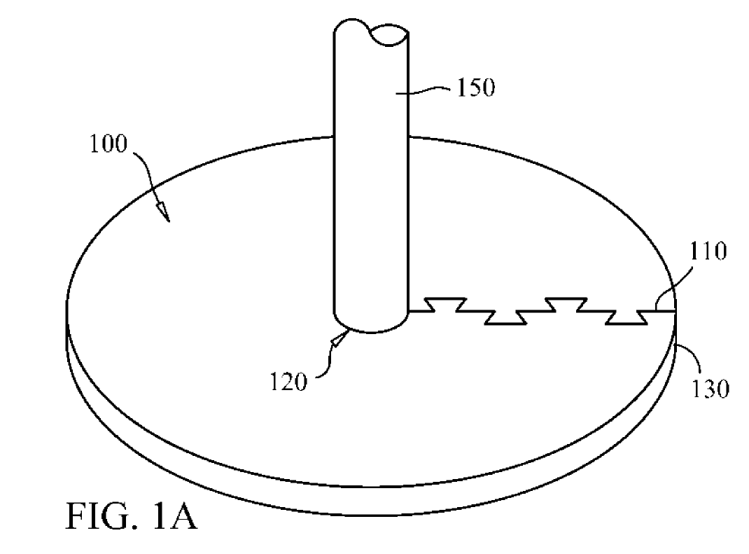

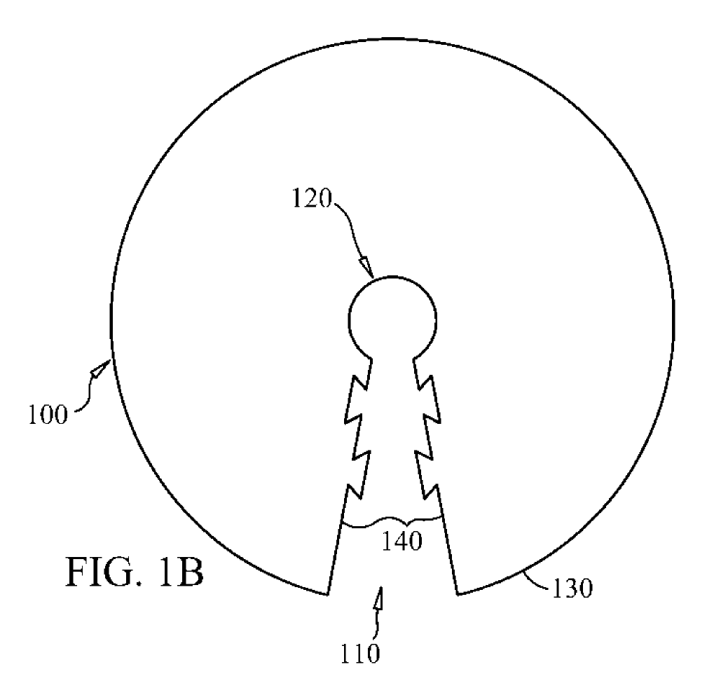

According to the present invention the mat 100 has a slot 110 that radiates from a center portion 120 to an outer edge 130. The slot 110 has slot sides 140. FIG. 1A shows a pole mat according to the present invention with the slot in a closed position. FIG. 1B shows a pole mat according to the present invention with the slot in an open position. Slot sides 140 can be configured to interlock or mate together such that when slot 110 is in a closed position slot sides 140 form a seamless or nearly seamless appearance. This interlocking system can include, but is not limited to, having slot sides 140 interlock in a dovetail pattern. Furthermore, when slot 110 is in a closed position slot sides 140 will not become unintentionally separated, particularly when subjected to the forces created by landscaping equipment or weather. Slot sides 140 may be glued or otherwise secured together to further prevent the unintentional separation of the slot sides 140 when slot 110 is in a closed position.

Center portion 120 can be configured to match the outer perimeter of the post 150. For example, center portion 120 can be circular or square in shape. Other shapes may include, but are not limited, to “U-channel” shapes commonly used in road side sign construction. By matching the shape of center portion 120 to the outer perimeter of the post 150, mat 100 can be tightly fitted around the post 150.

A tight fit of the mat 100 around the post provides at least two advantages. First, the mat 100 grips the post 150 such that the mat 100 will not be lifted off the ground unintentionally, such as by winds or landscaping equipment. Secondly, a tight fit prevents grasses, weeds, or other vegetation from growing between the mat 100 and the post 150. Third, using a pre-cut or pre-shaped center portion 120 eliminates the need for a user to cut the center portion 120 to suit common applications.

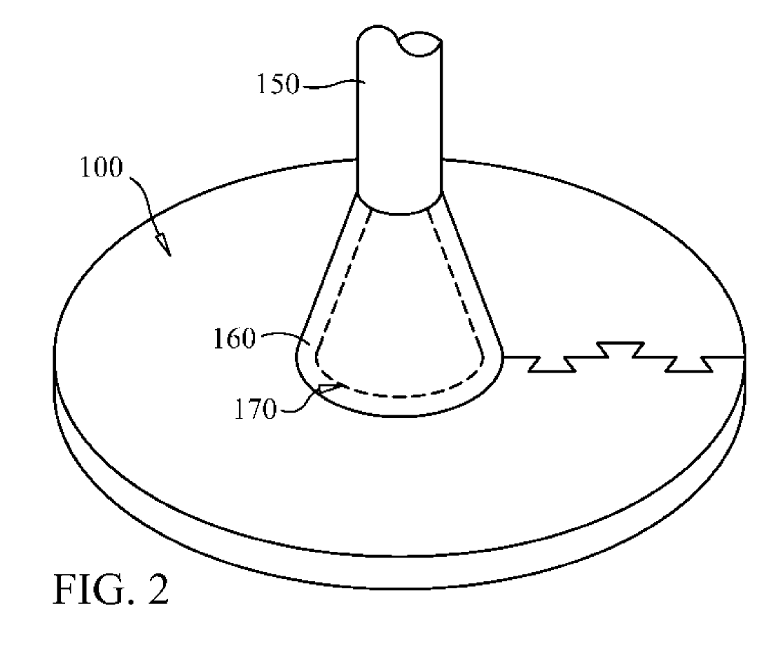

To further the advantages of center portion 120 having a tight fit around post 100, a post cone 160 may be added to or integrally formed with the mat. FIG. 2 shows pole mat according to the present invention having a post cone. Post cone 160 extends vertically up the post 150. The inner surface 170 of the post cone 160 provides additional contact area between the post 150 and the mat 100. The added contact area increases the grip of the mat 100 on the post 150, thereby reducing the likelihood the mat 100 will be lifted from the ground. Furthermore, the increased contact area also reduces the chances of vegetation growing between the mat 100 and the post 150. The post cone 160 also has the added advantage of protecting the base of the post 150 from landscaping equipment or other items operating in the vicinity of the post 150. Furthermore, the post cone 160 can improve the aesthetic appearance of the post 150 by concealing rust or other blemishes on the post 150 base.

Mat 100 can be constructed from a variety of materials. Preferably mat 100 is flexible, can maintain its shape during long term exposure to a range of weather conditions and temperatures, and is thin enough to not interfere with landscaping equipment. However, the mat 100 is preferably thick enough so that the mat 100 has sufficient weight to allow the mat 100 to maintain contact with the ground. In a preferred embodiment, the mat is one-half inch thick. Preferably the mat 100 material is nonporous and opaque, thereby preventing water and light from reaching the ground in the area covered by the mat. In various preferred embodiments, mat 100 can be constructed from rubber or recycled rubber compounds. Mat 100 can also be colored and or textured to blend into its surroundings or take on the decorative appearance of much or other similar materials.

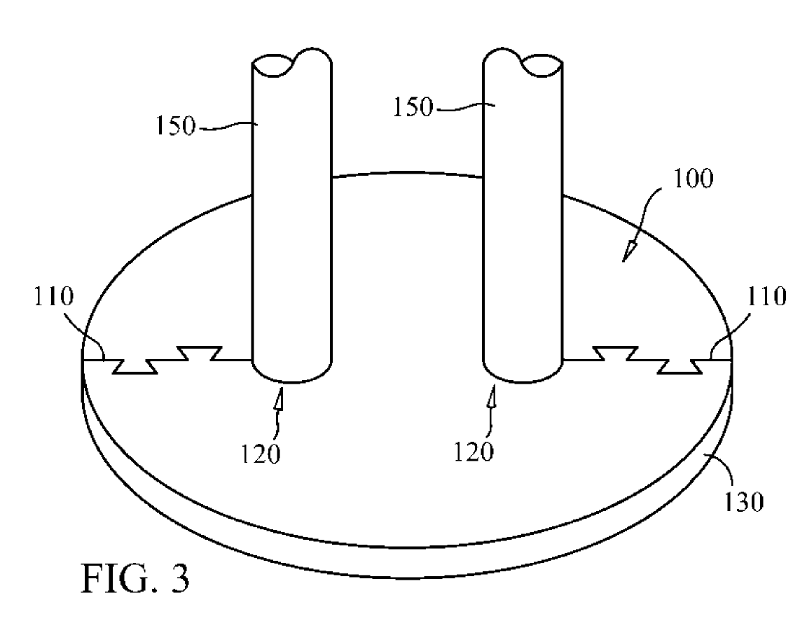

In various preferred embodiments, a mat 100 can be configured for a multiple post application, such as a road sign having two or more support posts 150. FIG. 3 shows a pole mat according to the present invention for a multiple post application. In these embodiments, there are center portions 120 for each of the posts 150. Slot 110 can be configured such that there is a separate slot 100 for each center portion 120 or a single slot 110 that allows access to each center portion 120, or a combination thereof.

While specific embodiments have been illustrated and described, numerous modifications come to mind without significantly departing from the spirit of the invention and the scope of protection is limited by the scope of the accompanying claims.

What is claimed is:

1. A mat for the base of a pole, wherein the mat comprises:
a mat body having an outer edge,
a center portion located within said outer edge and configured to tightly fit about an outer perimeter of said pole, and
a slot having interlocking slot sides radiating from said center portion to said outer edge.

2. The mat for the base of a pole according to claim 1, wherein said interlocking slot sides interlock in a dovetail pattern.

3. The mat for the base of a pole according to claim 1, wherein said interlocking slot sides are secured by gluing means.

4. The mat for the base of a pole according to claim 1, wherein said center portion is substantially circular in shape.

5. The mat for the base of a pole according to claim 1, wherein said center portion is substantially square in shape.

6. The mat for the base of a pole according to claim 1, wherein said center portion is a “U” shape.

7. The mat for the base of a pole according to claim 1, wherein said center portion is a U-channel shape.

8. The mat for the base of a pole according to claim 1, further comprising a post cone extending vertically up said post from said center portion.

9. The mat for the base of a pole according to claim 8, wherein said post cone comprises an inner surface, and wherein said inner surface grips said pole.

10. The mat for the base of a pole according to claim 1, wherein an upper surface of said mat body is colored.

11. The mat for the base of a pole according to claim 1, wherein an upper surface of said mat body is textured.

12. The mat for the base of a pole according to claim 11, wherein said upper surface of said mat body is textured to resemble mulch.

13. The mat for the base of a pole according to claim 1, wherein said mat is constructed from recycled rubber components.

14. The mat for the base of a pole according to claim 1, wherein said mat is nonporous.

15. The mat for the base of a pole according to claim 1, where said mat is opaque.

16. The mat for the base of a pole according to claim 15, wherein mat is nonporous.

17. The mat for the base of a pole according to claim 1, wherein said mat body is one-half inch thick.
